(19) United States
(12) Patent Application Publication
(10) Pub. No.: US 2021/0399293 A1
(43) Pub. Date: Dec. 23, 2021

(54) METAL ELECTRODE

(71) Applicant: Terence W. Unger, Monterey, CA (US)

(72) Inventor: Terence W. Unger, Monterey, CA (US)

(21) Appl. No.: 17/465,407

(22) Filed: Sep. 2, 2021

Related U.S. Application Data
(60) Provisional application No. 63/122,968, filed on Dec. 9, 2020.
(60) Provisional application No. 63/121,941, filed on Dec. 6, 2020.

(51) Int. Cl. H01M 4/36; H01M 10/0561; H01M 10/0525; H01M 4/38; H01M 4/587

(52) U.S. Cl. CPC H01M 4/366; H01M 10/0561; H01M 10/0525; H01M 2004/028; H01M 4/587; H01M 2300/002; H01M 4/382

(57) ABSTRACT

A multi-section electrode for lithium batteries, wherein the multi-section electrode includes a plurality of sections, each section of the plurality of sections divided into a major part and a minor part. The major part can have a larger path to the current collector compared to the minor part which results in faster charging and discharging of the major part in comparison with the minor section, wherein the minor section can retain a charge for longer duration and help reduce electrode fatigue and breakdown.

### CROSS-REFERENCE TO RELATED APPLICATIONS

This application claims priority from a U.S. Provisional patent application Ser. No. 63/121,941 filed on Dec. 6, 2020, which is incorporated herein by reference in its entirety. This application also claims priority from a U.S. Provisional patent application Ser. No. 63/122,968 filed on Dec. 9, 2020, which is incorporated herein by reference in its entirety. This application also incorporates by reference the contents of U.S. published patent No. 9,236,598 granted on Jan. 12, 2016.

### FIELD OF INVENTION

The present invention relates to an electrode, and more particularly, the present invention relates to an improved multi-section electrode for lithium batteries.

### BACKGROUND

Fatigue of electrodes is the most common reason for the failure of batteries in long term. The fatigue is generally a result of cyclic mechanical stresses acting on the electrode and which are directly related to the number of charge-discharge cycles of a battery. In lithium batteries, the metal lithium and graphene generally get fatigued and start breaking down after many cycles.

Thus, a desire is there for improved electrode designs that can withstand fatigue and to obtain maximum efficiency and life from the electrode.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a multi-section electrode that can withstand fatigue for longer life.

It is another object of the present invention that the electrode is economical to manufacture.

It is still another object of the present invention to provide an electrode for lithium batteries.

It is yet another object of the present invention that the lithium battery having the disclosed electrode does not get discharge completely.

It is still an additional object of the present invention that the disclosed electrode can increase the efficiency of a battery.

In one aspect, disclosed is a multi-section electrode for lithium batteries, wherein the multi-section electrode includes a plurality of sections, each section of the plurality of sections divided into a major part and a minor part. The major part can have a larger path to the current collector compared to the minor part which results in faster charging and discharging of the major part in comparison with the minor section, wherein the minor section can keep a charge for a longer duration.

In one aspect, the major part is about 80-90% and the minor part is about 10-20%. The minor part can be doped with a higher resistance material, or a part of the minor part can be doped with a higher resistance material, or a part of the minor part can be doped with a higher resistance material. For example, Nickle that may allow the minor part to retain the charge for longer duration.

In one aspect, the charge bus and discharge bus can be connected to the major part, while the minor part can only be connected to the charge bus but not the discharge bus directly,

In one aspect, the plurality of sections of the multi-section electrode can be connected to control unit which can selectively connect one or more sections to the discharge bus or charge bus.

In one aspect, the multi-section electrode can be made of graphene, and a layer of metal lithium can be deposited as a top layer on the graphene layer. The graphene layers can have a solid metallic edge. In one case, an additional layer of graphene can be provided, wherein the lithium metal layer can be sandwiched between the graphene layers.

In one aspect, disclosed is an electrode for a lithium metal or ion battery that includes a plurality of sections formed by segregation of the electrode, each section comprises a major part and a minor part, the major part configured to discharge faster than the minor part, the minor part configured to retain a charge for a longer duration compared to the major part; a charge bus continuous along a periphery of the electrode; and a discharge bus continuous along the periphery of the electrode.

These and other objects and advantages of the embodiments herein and the summary will become readily apparent from the following detailed description taken in conjunction with the accompanying drawings.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows an exemplary embodiment of the multi-section electrode, according to the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a multi-section electrode that can be used in lithium metal or lithium-ion batteries that can withstand fatigue conditions resulting in longer battery life. Such batteries having the disclosed electrode can withstand more charge cycles than a convention lithium ion or metal battery.

Disclosed is a multi-section electrode made of graphene or carbon nanotubes (CNTs) having a solid metal edge surrounding the electrode. The solid metallic edge can be gold plated. On the graphene can be a layer of metallic lithium. Additionally, layer(s) of graphene can be deposited on the metal lithium layer, such as the metal lithium layer is sandwiched between the graphene layers. Such a design of electrode may omit the need for anode in a lithium battery. The multi-section electrode can then be segregated into sections using a suitable method. For example, laser cutting can be used to segregate the electrode into sections. The sections of the multi-section electrode can be connected to a control unit and using a suitable algorithm, the control unit can switch the sections on and off to increase the battery efficiency and life.

To prevent fatigue of the electrode, each section of the multi-section electrode can be further divided into a major part and a minor part. The major part can constitute 80-90% of the section area while the minor section can be about 10-20% of the section area. The major part of the section can discharge faster than the minor part, thus the minor part can retain charge for a longer duration which can prevent electrode fatigue increasing the longevity or life cycle of the disclosed electrode. In one case, the minor part can be selectively doped with a higher resistance material, such as Nickle. The additional resistance decreases the discharge rate compared to the major part, and the minor part can retain the charge for a longer duration, in one case, the major part and the minor part can be connected to the charge bus but only the major part can be connected to the discharge bus directly. The minor part can retain at least 10% charge and prevents complete discharging of the battery.

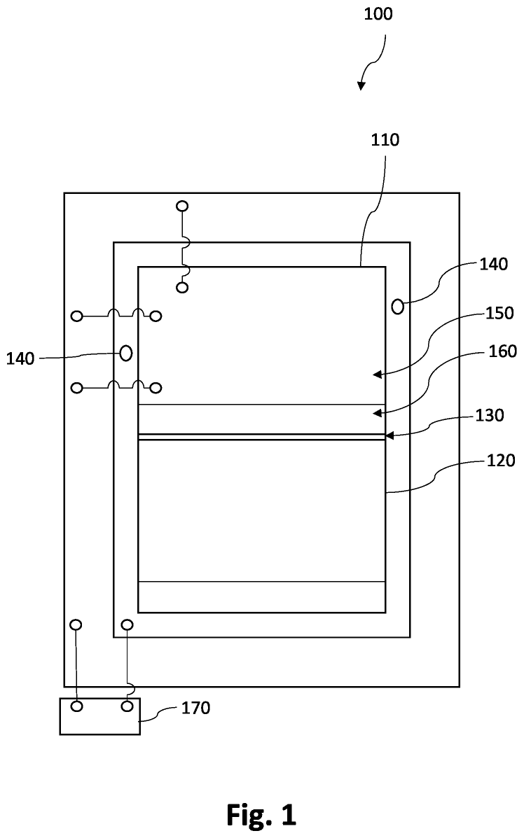

Referring to FIG. 1, which shows an exemplary embodiment of the electrode 100 segregated into two sections, the first section 110 and a second section 120. The two sections can be divided by laser to form a gap 130. The gap can optionally fill with an insulative material to isolate the two sections. Each section can have two charge busses as shown in FIG. 1. The first section 110 is shown to have two charge busses 140. The first section 110 can have a major part 150 and a minor part 160. It is to be understood that the second section can also have the major part and the minor part. A control unit 170 can also be seen, wherein the control unit 170 can switch the regulate the charging and discharging of the first section and the section of the electrode.

Also, disclosed is a battery based on lithium-ion or lithium metal. The battery can include the above-described electrode according to the present invention. The disclosed segregated electrode is made of graphene or carbon nanotubes having a surrounding metallic edge. A layer of lithium can be deposited on the top surface of the graphene electrode. Further, a layer of graphene or carbon nanotube can be deposited on the metal lithium layer, such as the metal lithium layer can be sandwiched between the layers of graphene or CNTs. Therefore, a need for an anode is no longer there, and the disclosed battery can only have the cathode but no separate anode. Moreover, the disclosed battery can include electrolytes, such as lithium-nickel-manganese-cobalt to improve the battery performance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An electrode for a lithium metal or ion battery comprises:
a plurality of sections formed by segregation of the electrode, each section comprises a major part and a minor part, the major part configured to discharge faster than the minor part, the minor part configured to retain a charge for a longer duration compared to the major part;
a charge bus continuous along a periphery of the electrode; and
a discharge bus continuous along the periphery of the electrode.

2. The electrode according to claim 1, wherein the major part is connected to the charge bus and the discharge bus, the minor part is connected to the charge bus but not to the discharge bus.

3. The electrode according to claim 1, wherein the electrode comprises two sections.

4. The electrode according to claim 1, wherein the electrode is made of graphene having a surrounding solid metallic edge and a layer of metal lithium deposited on the graphene.

5. The electrode according to claim 4, wherein the electrode further comprises a layer of graphene deposited on the layer of metal lithium, such as the layer of metal lithium is sandwiched between the graphene forming the electrode and the layer of graphene.

6. The electrode according to claim 1, wherein the electrode is made of carbon nanotubes having a surrounding solid metallic edge and a layer of metal lithium deposited on the carbon nanotubes.

7. The electrode according to claim 1, wherein the major part is about 80-90% of the each section and the minor part is about 10-20% of the each section.

8. The electrode according to claim 1, wherein the minor part is doped with a high resistance material, wherein the high resistance material configured to reduce a discharge/charge rate of the minor part.

9. The electrode according to claim 8, wherein the high resistance material is nickel.

10. The electrode according to claim 1, wherein at least a section of the minor part is doped with a high resistance material, wherein the high resistance material configured to reduce a discharge/charge rate of the minor part.

11. A battery comprising:
a cathode comprising:
a plurality of sections formed by segregation of the cathode, each section comprises a major part and a minor part, the major part configured to discharge faster than the minor part, the minor part configured to retain a charge for a longer duration compared to the major part;
a charge bus continuous along a periphery of the cathode; and
a discharge bus continuous along the periphery of the cathode.

12. The battery according to claim 11, wherein the battery further comprises an electrolyte, the electrolyte comprising lithium-nickel-manganese-cobalt electrolyte gel.

13. The battery according to claim 11, wherein the major part is connected to the charge bus and the discharge bus, the minor part is connected to the charge bus but not to the discharge bus.

14. The electrode according to claim 11, wherein the minor part is doped with a higher resistance material.

15. The electrode according to claim 14, wherein the high resistance material is nickel.

16. The electrode according to claim 11, wherein at least a section of the minor part is doped with a high resistance material, wherein the high resistance material configured to reduce a discharge/charge rate of the minor part.
